(19) United States
(12) Patent Application Publication
(10) Pub. No.: US 2004/0200765 A1
(43) Pub. Date: Oct. 14, 2004

(54) In-tank return line filter element and hydraulic reservoir with same

(76) Inventors: Steven R. Evanovich, Pittsburgh, PA (US); Augustus O. Schroeder, Pittsburgh, PA (US); Christopher B. Bortnik, Warrendale, PA (US)

Correspondence Address: Blynn L. Shideler, The BLK Law Group, Suite 200, 3500 Brootree Road, Wexford, PA, 15090, US

(21) Appl. No.: 10/410,875

(22) Filed: Apr. 10, 2003

(51) Int. Cl. B01D 35/14

(52) U.S. Cl. 210/130; 210/434; 210/445; 210/459; 210/167

(57) ABSTRACT

A bottom mounted, in-line, in-tank return line filter element is mounted in a hydraulic reservoir. The reservoir includes a holding tank, at least one outlet from and return line to the reservoir, an in-tank return line within the reservoir and extending to one return line, and an in-tank return line filter element mounted within the in-tank return line. The in-tank return line filter element includes an end cap, a filter media and a by-pass valve coupled thereto. The end cap includes a central fluid opening, a mounting surface for the filter media, and a peripheral attaching mechanism for attaching the filter element to the in-tank return line to form a filter assembly. The mounting surface is positioned between the central opening and the attaching mechanism such that a bottom mounted in-line, in-tank, outside in filter element is provided.

### BACKGROUND OF THE INVENTION

1. Field of the Invention

The present invention relates to an in-tank return line filter element. Specifically, the present invention relates to an in-tank return line filter element and a hydraulic reservoir that incorporates the filter element.

2. Background Information

Hydraulic reservoirs are used to hold hydraulic fluid that can be utilized by hydraulic systems, such as used in heavy machinery, including cranes, backhoes, demolition shears, bulldozers, and the like. In hydraulic systems, it is important to keep the hydraulic fluid free of debris. Consequently, filter units or filter assemblies have been incorporated in the hydraulic systems to filter debris from the hydraulic fluid.

U.S. Pat. Nos. 6,116,454; 6,475,380 and 6,508,271 disclose hydraulic reservoir designs that incorporate specific filter assemblies therein (i.e. in-tank filter elements), and these patents are incorporated herein by reference. The filter elements can be on the outlet lines, as shown in the '454 patent or in the inlet lines as shown in the '380 and '271 patents. A filter element on the outlet or suction side of a hydraulic reservoir is generally a simple strainer. Placing the filter element in the inlet or return lines that extends to the reservoir, as shown in the '271 and '380 patents provides certain advantages relating to the energy required by filtration and returning of the fluid to the reservoir.

The large majority of in-tank filter elements for hydraulic reservoirs utilize a return line filter element of some kind. One known or common example is a forming a partition or separate box structure within the hydraulic reservoir and incorporating a top mounted, or drop-in, filter element therein. A similar known configuration is to have the filter element as part of a larger filter assembly which is “dropped” into the top of the container with the return lines connected directly to the head of the filter assembly. This filter element is also a top mounted structure. The term “top mounted” refers to access or mounting direction in that the filter element is accessed and replaced through the top of the reservoir, such as in the '271 patent. These top mounted filter elements result in a large amount of components and design complexity in the filter assembly due to sealing requirements and the like that are necessary.

There is a need in the industry for a simple, efficient, in-tank, in-line filter element for a return line of a hydraulic reservoir.

### SUMMARY OF THE INVENTION

The problems set out above are solved by the hydraulic reservoir having an in-tank return line filter element according to the present invention. The hydraulic reservoir according to the invention includes a holding tank for holding fluid, at least one outlet from the hydraulic reservoir, at least one return line to the hydraulic reservoir, an in-tank return line extending within the hydraulic reservoir and extending to one return line, and an in-tank return line filter element mounted within the in-tank return line. The in-tank return line filter element is formed of an end cap, a filter media coupled to the end cap and a by-pass valve coupled to the filter media. The end cap includes a central opening for fluid, a mounting surface for attaching the filter media, and an attaching mechanism at a peripheral edge of the end cap for attaching the filter element to the in-tank return line. The in-tank return line and the filter element form a filter assembly for the hydraulic reservoir. The filter element is a “bottom” mounted structure, relative to the in-tank return line in the hydraulic reservoir. The mounting surface is positioned between the central opening and the attaching mechanism such that an in-line, in-tank, outside-in, bottom mounted, filter element is provided.

These and other advantages of the present invention will be clarified in the description of the preferred embodiment taken together with the attached figures wherein like reference numerals represent like elements throughout.

### BRIEF DESCRIPTION OF THE DRAWINGS

FIG. 1 is a sectional view of an in-tank return line for a hydraulic reservoir having a filter element according to a first embodiment of the present invention; and

FIG. 2 is a sectional view of an in-tank return line for a hydraulic reservoir having a filter element according to a second embodiment of the present invention.

### DETAILED DESCRIPTION OF THE PREFERRED EMBODIMENT

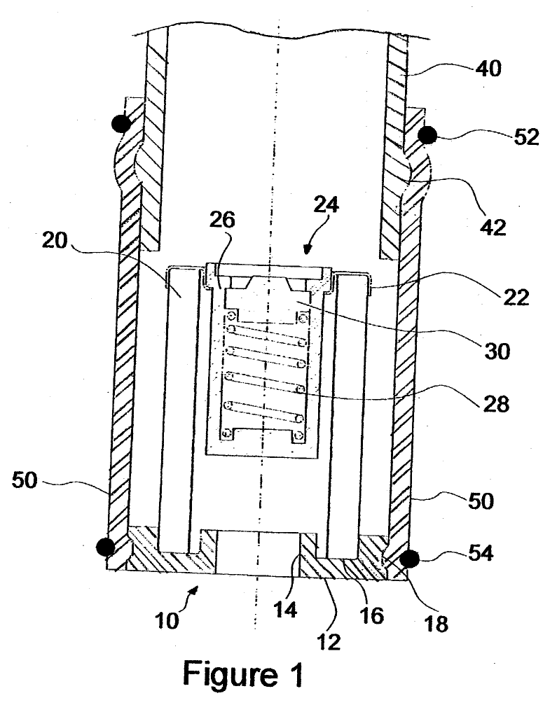

FIG. 1 is a schematic view of a hydraulic reservoir (not shown completely) having an in-tank return line filter element 10 according to the present invention. The term “hydraulic reservoir” within the meaning of this application refers to a container for holding working fluid that is conveyed and returned to the reservoir in a circulating system or a holding container for a fuel. Generally, the working fluid is for hydraulic power or for lubrication such as petroleum and water-based fluids. The hydraulic reservoir may be metal (e.g. steel) or plastic as known in the art. U.S. Pat. No. 6,508,271 discusses rotomolding of hydraulic reservoirs and is incorporated herein by reference. The hydraulic reservoirs utilizing the present invention have one or more outlets for supplying hydraulic fluid contained in the reservoir to associated hydraulic systems as needed. Additionally the hydraulic reservoirs include one or more return lines extending to hydraulic reservoir, preferably the upper portion of the hydraulic reservoir, for returning hydraulic fluid to the hydraulic reservoir. The hydraulic reservoir is vented to atmosphere. Additionally, as will become apparent, the hydraulic reservoir will need to have a man-way opening, or clean out access for replacement of the bottom mounted filter element 10. The term “bottom mounted” within the meaning of this specification means that the filter element 10 will be withdrawn (i.e. replaced) in a direction of the flow of the in-tank return line and the filter element 10 will be attached to the return line by moving the filter element along the direction opposite the flow in the in-tank return line. This is the opposite of the “top mounted” filter elements of the prior art. These terms are not intended to define a specific direction of the in-tank return line which may extend from the top, bottom or side of the hydraulic reservoir. The details of the hydraulic reservoir itself are known in the art and are not described herein in detail.

The bottom mounted, in-tank return line filter element 10 includes an end cap 12 coupled to an in-tank return line as described here and after. The end cap 12 includes a central opening 14 for receiving the hydraulic fluid through the filter element 10 and into the hydraulic reservoir holding tank. The end cap 12 further includes an upper mounting surface 16 and a peripheral attachment surface 18. The attachment surface 18 can include a groove as shown in FIG. 1, or an external bead, pair of spaced beads projected beads or other associated configuration to assist in the attachment of the filter element 10 to the in-tank return line.

A filter media 20 is bonded to the mounting surface 16 such as through an epoxy or other conventional attachment techniques. The filter media 20 includes a filtering structure and a support tube providing structural support (i.e. a backbone) to the filter media 20 as is known in the art.

A mounting flange 22 is attached to a distal end of the filter element 20 opposite the end cap 12. The mounting flange 22 allows for the attachment of a bypass valve assembly 24. The bypasse valve assembly 24 includes an extended valve housing 26, a spring 28 and a valve body 30.

The end cap 12, a filter media 20, mounting flange 22 and bypass valve assembly 24 combined to form the bottom mounted, in-tank return line filter element 10 according to the present invention. The in-tank return line filter element 10 is positioned within an in-tank return line that extends into the hydraulic reservoir to form a filter assembly.

In FIG. 1 the in-tank return line is formed by a first return line portion 40 extending from the return line at the periphery of the hydraulic reservoir. Within the meaning of this application a “return line” references that portion of the hydraulic circuit returning fluid to the hydraulic reservoir that is exterior to the hydraulic reservoir and the “in-tank return line” is that portion of the fluid circuit that is located within the hydraulic reservoir. The first portion 40 includes an external barb 42 at a lower portion thereof. The in-tank return line of FIG. 1 includes a second portion formed by hydraulic hose 50. The hose 50 is coupled to the first portion 40 with a hose clamp 52 positioned above the external barb 42. Any other suitable compression fitting or other mechanical connection may be utilized in place of the hose clamp 52. When extending from an upper portion of the hydraulic reservoir, the in-tank return line may extend past the centerline of the reservoir and preferably into a position well below the normal fluid level line within the hydraulic reservoir holding tank. This design will help avoid foaming within the fluid in the holding tank and will generally improve the fluid flow characteristics within the hydraulic reservoir.

The bottom mounted filter element 10 is attached to the in-tank return line by a hose clamp 54 securing the hose 50 to the attachment surface 18 of the end cap 12. The groove on the attachment surface 18 will assist in maintaining the filter element 10 in position. As with hose clamp 52, any other suitable compression fitting or other mechanical connection may be utilized in place of the hose clamp 54.

In operation the hydraulic fluid is returned to the hydraulic reservoir through the return line and into the in-tank return line formed by first portion 40 and hose 50. It will be apparent from a review of the figure that the in-tank return line, specifically the hose 50, forms the housing for the filter element 10, whereby the filter element 10 and the in-tank return line form a filter assembly. The returning hydraulic fluid will, normally, flow though the filter media 20, and through the opening 14 into the hydraulic reservoir holding tank. This forms an outside-in filter element that uses the return line pressure for filtration. In other words no additional work or energy is needed for the filtration process, and there is no additional drag on the system.

The bypass valve assembly 24 operates in a conventional manner as an emergency bypass. The spring 28 is set to a by-pass pressure. If the filter media 20 is close to reaching its capacity (i.e. it is clogged), the pressure in the in-tank return line will increase until it reaches the by-pass pressure of the spring 28. At the by-pass pressure the spring 28 will be depressed by the valve body 30 allowing fluid to flow through openings (not shown) in the valve housing 26 to the opening 14. Operation of the by-pass valve assembly 24 will by-pass the filter media 20 as known in the art. The in-line, in-tank return line positioning of the filter element 10 allows for a simple by-pass valve alarm to be utilized. The hydraulic reservoir holding tank is vented to atmosphere and will therefore be at atmospheric pressure. A simple pressure sensor (not shown) can be connected to the in-tank return line to measure in-tank return line pressure. An alarm or other indication can be set at, or slightly below the by-pass pressure to give warning of the by-pass activation. In other words the alarm can indicate that immediate maintenance is required. The standard maintenance will be the replacement of the filter element 10.

The filter element 10 is designed for easy replacement and is bottom mounted relative to the in-tank return line. The replacement is through the man-way or cleanout access in the hydraulic reservoir. The operator will release the hose clamp 54 to disengage the filter assembly 10. With the filter element 10 disengaged, the old filter element 10 can be removed and a new filter element 10 inserted. The new filter element 10 can be secured by reattaching the hose clamp 54. The “bottom mounting” can be more precisely defined as a mounting that attaches to the in-tank return line opposite to the direction of flow and is disengaged in the direction of flow.

The filter element 10 can be used with a variety of existing hydraulic reservoirs. All that is required is the presence of an in-tank return line sufficient for receiving the filter element 10 to form a filter assembly therein, and an access port for inserting and replacing the filter element 10. It is anticipated that the first portion 40 and hose 50 may also be retrofitted onto existing hydraulic tanks to utilize the filter element 10.

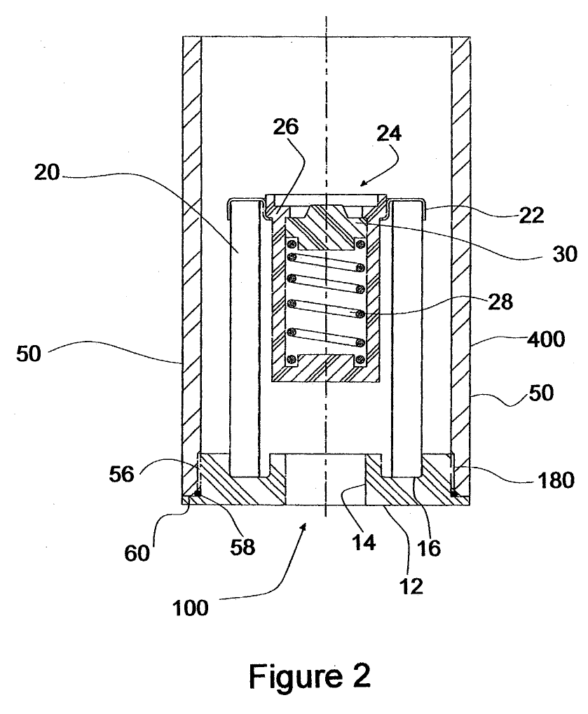

Various changes may be made to the filter element 10 as will be apparent to those in the art. For example the end cap 12 may be machined from metal with a sealing O-ring or may be injection molded to provide a thinner profile. FIG. 2 illustrates a second embodiment of the present invention which incorporates some changes. The bottom mounted, in-tank return line filter element 100 includes an end cap 120 coupled to an in-tank return line 400, that may be a steel tube. The end cap 120 includes a central opening 14 and an upper mounting surface 16 as discussed above. The end cap 120 includes a modified peripheral attachment surface 180 that includes threads 56 to assist in the attachment of the filter element 10 to the in-tank return line 400. An O-ring 58 and sealing gasket 60 on a shoulder of the end cap 120 are also provided for sealing the filter element 100.

A filter media 20 is bonded to the mounting surface 16 and a mounting flange 22 is attached to a distal end of the filter media 20 opposite the end cap 12, as described above in connection with filter element 10. A bypass valve assembly 24, which includes an extended valve housing 26, a spring 28 and a valve body 30, is attached to the mounting flange 22.

The end cap 120, a filter media 20, mounting flange 22 and bypass valve assembly 24 combined to form the in-tank return line filter element 100 according to the modified embodiment of the present invention. The bottom mounted in-tank return line filter element 100 is positioned within an in-tank return line 400 that extends into the hydraulic reservoir. In FIG. 2 the in-tank return line 400 is formed by a single tube with threads at the end to engage with threads 56 of the end cap 120. The line 400 is in place of the first return line portion 40 and hydraulic hose 50 associated with filter element 10. The filter element 100 is threaded to the in-tank return line 400 by threads 56 of the attachment surface 18 of the end cap 12.

In operation the hydraulic fluid is returned to the hydraulic reservoir through the return line and into the in-tank return line 400. The in-tank return line 400 forms the housing for the filter element 100 and combines therewith to form a filter assembly. The returning hydraulic fluid will, normally, flow though the filter element 20, and through the opening 14 into the hydraulic reservoir holding tank. This forms an outside-in filter element that uses the return line pressure for filtration. In other words no additional work or energy is needed for the filtration process, and there is no additional drag on the system. The bypass valve assembly 24 operates in a conventional manner as an emergency bypass, as described above. As with the filter element 10, a simple pressure sensor (not shown) can be connected to the in-tank return line 400 to measure in-tank return line pressure, whereby an alarm, or other indication, can be set at, or slightly below the by-pass pressure to give warning of the by-pass activation indicating that immediate maintenance (e.g. filter element 100 replacement) is required.

The bottom mounted filter element 100 is also designed for easy replacement. The replacement is through the man-way or cleanout access in the hydraulic reservoir. The operator will unthread the filter element 100 to disengage the filter element 100. External flats may be provided on the attachment surface 180, internal flats (i.e. an allen head structure) may be provided on the opening 14, or other rotation assisting mechanism may be added to assist in the rotation of the filter element 100. The old filter element 100 can be removed and a new filter element 100 inserted. The new filter element 100 can be secured by threading the end cap 120 to the return line 400. The filter element 100 can also be used with a variety of existing hydraulic reservoirs. All that is required is the presence of an in-tank return line 400 sufficient for receiving the filter element 100, and an access port for inserting and removing the filter element 100.

It is anticipated that the return line 400 may also be retrofitted onto hydraulic tanks to utilize the filter element 100. The retrofitting may simply be by a peripheral plate surrounding the return line 400 that is attached by bolts or the like to the hydraulic reservoir. Appropriate sealing (e.g. gasket and or O-ring) of the plate would be required. This modification may make the replacement of the filter element 100 easier in that the entire return line 400 can be removed from the reservoir to access and replace the filter element 100. The filter element 100 is still a “bottom mounted” structure, it is only the method of accessing the filter element 100 that may be different with this modification.

The other advantage of the present invention will be apparent to those in the art. The invention has been described with reference to the preferred embodiment. Obvious modifications and alterations will occur to others upon reading and understanding the proceeding detailed description. It is intended that the invention be construed as including all such modifications and alterations. The scope of the present invention is defined by the appended claims and equivalents thereto.

What is claimed is:

1. A hydraulic reservoir comprising:
a holding tank for holding fluid;
at least one outlet from the hydraulic reservoir;
at least one return line to the hydraulic reservoir;
an in-tank return line extending within the hydraulic reservoir and extending to one said return line; and
a bottom mounted in-tank return line filter element mounted within said in-tank return line, said in-tank return line filter element comprising an end cap, a filter media coupled to the end cap and a by-pass valve coupled to the filter media, wherein the end cap includes a central opening for fluid, a mounting surface for attaching said filter media and an attaching mechanism at a peripheral edge of the end cap for attaching the filter element to said in-tank return line.

2. The hydraulic reservoir of claim 1 wherein said in-tank return line includes of a hose which forms a housing for said in-tank filter element, and wherein said mounting surface is positioned between the central opening and the attaching mechanism.

3. The hydraulic reservoir of claim 2 wherein said in-tank return line includes a first portion having an external barb at one end coupled to said hose through a hose clamp.

4. The hydraulic reservoir of claim 2 wherein said attaching mechanism of said in-tank return line filter element includes a groove aligned with a hose clamp coupling said hose to said filter element.

5. The hydraulic reservoir of claim 1 wherein said attaching mechanism of said in-tank return line filter element includes threads engaging threads on said in-tank return line.

6. The hydraulic reservoir of claim 5 wherein said attaching mechanism of said in-tank return line filter element includes a sealing O-ring.

7. An in-tank return line filter assembly for a hydraulic reservoir, said in-tank return line filter assembly comprising:
an in-tank return line extending within the hydraulic reservoir and extending to a return line of the reservoir, and
a bottom mounted in-tank return line filter element mounted within said in-tank return line, said in-tank return line filter element including an end cap, a filter media coupled to the end cap and a by-pass valve coupled to the filter media, wherein the end cap includes a central opening for fluid, a mounting surface for attaching said filter element and an attaching mechanism at a peripheral edge of the end cap for attaching the filter assembly to said in-tank return line.

8. The in-tank return line filter assembly of claim 7 wherein said mounting surface is positioned between the central opening and the attaching mechanism providing an outside-in filter assembly.

9. The in-tank return line filter assembly of claim 8 wherein said in-tank return line includes in-tank return line includes of a hose which forms a housing for said in-tank filter element and a first portion having an external barb at one end coupled to said hose through a hose clamp.

10. The in-tank return line filter assembly of claim 8 wherein said attaching mechanism of said in-tank return line filter assembly includes a groove aligned with a hose clamp coupling said hose to said filter assembly.

11. The in-tank return line filter assembly of claim 7 wherein said attaching mechanism of said in-tank return line filter assembly includes threads engaging threads on said in-tank return line.

12. The in-tank return line filter assembly of claim 11 wherein said attaching mechanism of said in-tank return line filter assembly includes a sealing O-ring.

13. A bottom mounted in-tank return line filter element for mounting within an in-tank return line of a hydraulic reservoir, said in-tank return line filter element comprising:
an end cap;
a filter media coupled to the end cap; and
a by-pass valve coupled to the filter media, wherein the end cap includes a central opening for fluid, a mounting surface for attaching said filter media and an attaching mechanism at a peripheral edge of the end cap for attaching the filter element to the in-tank return line, and wherein said mounting surface is positioned between the central opening and the attaching mechanism providing an outside-in filter element.

14. The in-tank return line filter element of claim 13 wherein said attaching mechanism of said in-tank return line filter assembly includes a groove aligned with a hose clamp coupling said filter assembly to the in-tank return line.

15. The in-tank return line filter element of claim 13 wherein said attaching mechanism of said in-tank return line filter assembly includes threads engaging threads on the in-tank return line.

16. The in-tank return line filter element of claim 11 wherein said attaching mechanism of said in-tank return line filter assembly includes a sealing O-ring.
